(19) United States
(12) Patent Application Publication
(10) Pub. No.: US 2009/0140524 A1
(43) Pub. Date: Jun. 4, 2009

(54) Deployable submarine-hydroelectric generator for sea currents energy harvesting

(76) Inventor: Joseph B. Kejha, Meadowbrook, PA (US)

Correspondence Address: JOSEPH B. KEJHA, 1022 FREDERICK RD., MEADOWBROOK, PA, 19046, US

(21) Appl. No.: 11/998,593

(22) Filed: Nov. 30, 2007

(51) Int. Cl. F03B 13/10

(52) U.S. Cl. 290/54; 290/52

(57) ABSTRACT

Deployable submarine hydroelectric generator for conversion of kinetic energy of deep ocean currents into electricity by having an electric generator mounted in a sealed hydrodynamic, buoyant vessel with tail fins, and connected by a shaft to a rotary turbine blades at the tail end of the submarine vessel, which vessel is anchored at desired depth to the bottom of the ocean by a cable. The drag of the turbine blades causes the vessel to self-steer against the direction of the ocean current. An electric cable is also provided, connecting said electric generator with electric grid on the land. Such generator is out of sight, unlike windmills, and is environmentally friendly to the sea life, due to slow rotating blades. This clean electricity can also be used for production of low cost hydrogen by electrolysis of sea water.

### CROSS REFERENCE TO RELATED DOCUMENTS

The subject matter of the invention is described in the Disclosure Document of Joseph B. Kejha Ser. No. 591,521 filed on Dec. 9, 2005, and entitled “Deployable SubmarineHydroelectric Generator”.

### BACKGROUND OF THE INVENTION

1. Field of the Invention

This invention pertains to deployable submarine hydroelectric generator construction for harvesting the kinetic energy of any sea current, without building expensive structures from the bottom of the sea.

2. Description of the Prior Art

Prior art hydroelectric generators are known to convert kinetic energy of water into electricity. They usually require building an expensive dam to create a waterfall pressure to spin a turbine, or use a river current to spin a water wheel, which then drive an electric generator. Waves energy is usually captured by various floating devices, and the tidal current electric generator require a massive tower structure built from the bottom of the sea, which supports the generator.

This invention does not suffer from prior art problems and provides a simple low cost deep ocean energy harvesting method and structures, which result in lower cost, clean electricity production, and has many other advantages.

### SUMMARY OF THE INVENTION

It has now been found, that the energy of an ocean current, such as Gulf Stream can be easily harvested and converted into “green” clean electricity of virtually unlimited quantity, without building expensive and dangerous structures from the bottom of the ocean.

The sea or ocean currents are a form of solar energy, having unlimited, indefinite, and constant supply of kinetic energy, which is not being utilized. An electric generator harnessing a sea current will run constantly, unlike windmills. For example, the Gulf Stream has 50× bigger water flow than all the rivers flowing into the Atlantic from all continents, and is only 10 miles from the Florida Coast.

To eliminate any expensive structures fixed to the bottom of the sea, which at certain depths are impractical and very difficult to build, this invention solved the problem by enclosing-in or mounting the electric generator into a preferably droplet shape, preferably unmanned submarine vessel, which is tied or anchored to the bottom of the sea by a cable, or an equivalent line.

The vessel is hermetically sealed to withstand water pressure in the desired depths. The vessel should be balanced, so it maintains a horizontal position (level), of its longitudinal axis and is out of sight, submerged at any desirable depths into the sea current. The depths should be more than any ship's keel depths. The axial turbine blades are preferably located at the “tail end” of the submarine, so their drag will act as a vane, similar to a weather vane, auto steering the vessel properly against the sea current. Additional tail fin(s) vertical and horizontal may be also used for dynamic stability. The vessel, after anchoring should have preferably a remotely (wirelessly) controlled positive buoyancy, so when a servicing is needed, it can be brought to the sea surface by unwinding the anchoring cable by remote controls, and optionally additionally pumping water out from the ballast chamber(s). The electric wires/cable from the generator and/or added transformer can follow the anchoring cable to the bottom of the sea, and then continue to the nearby coast and on the land surface (or underground), where it can be connected to an electric power station and electric grid, or it can be connected to an electrolyzer on the land to provide clean hydrogen by electrolysis of water. Hydrogen fuel can be stored under high pressure and sold for fueling and driving vehicles, or for a chemical process.

The Gulf Stream for example flows only a few miles from the Florida coast, so it can supply practically unlimited electricity to that state and beyond. Virtually unlimited quantity of these generators can be placed into it. If these generators are placed far from the land, they still can be anchored to the bottom of the sea, but the electricity can be tapped from them by connecting and tying ships to them, which ships can have on-board electrolyzers to produce hydrogen from the sea water, and transporting the stored hydrogen to the land, or anywhere it is needed, including powering said ships, or other ships. My prior U.S. Pat. No. 7,036,616B1 describes long range hydrogen-electric hybrid vehicles, which can be the primary consumers of this indefinite source of hydrogen and clean energy, or this electricity can be used to charge the easily converted plug-in hybrid vehicles as described in my patent application Ser. No. 11/818,374, or to charge Navy submarines. These inventions can thus reduce global warming and eliminate our dependence on foreign oil. If all military vehicles would be converted to hydrogen fuel, as described, this fuel can be produced on ships located on the closest sea current to the conflict. It should be noted, that the submersible hydroelectric generators can be deployed (towed) by ships or submarines to the desired location, and will thus eliminate shipping of oil fuel for military operations worldwide, saving billions of dollars. (The turbine blades can be “feathered” during towing, to reduce drag).

The described deployable submarine-hydroelectric generators can include in its vessels also a high voltage transformer, and the generator may be an alternator for AC current and also 3-phase type. This provides for a long distance “transport” of electricity by a thinner cable (=lighter and cheaper) similar to land power grid system.

The weight of the electric components is not a problem in a water submersible vessel, which can easily carry very heavy loads, unlike airborne vehicles. The cooling of the transformer and generator can be by a water cooled heat exchangers (radiators) with pumps driven by the turbine or electricity from the generator. The vessel's shell and the anchoring cable should be preferably made from stainless steel, to guarantee long operational life. The electric cable should be of a well known undersea type design and the cooling liquid inside can be silicone oil.

“Proof of concept” of this invention can be tested on a small scale as follows:

An existing small electric generator can be enclosed in a proportionately sized vessel with a turbine as described above, and anchored under water in a river stream. The cable from the generator can be connected on the river bank to an electrical load, such as a bulb, motor, or electrolyzer, and the generator can be tested, and used.

It is apparent, that this invention is also useable for tapping into the river streams energy, without building dams.

In the remote control system, a GPS (global positioning system) should be included as well as, ID (identification) radio signal system, so each generator can be easily found. These generators are also environmentally friendly due to their “invisibility” and the absence of unsightly structures, unlike windmills.

The principal object of this invention is to produce large quantity of clean low cost electric energy and thus save fuels.

Another object of this invention is to lower CO₂ emissions and eliminate oil imports. Other objects and advantages of the invention will be apparent from the description and claims.

### BRIEF DESCRIPTION OF THE DRAWINGS

The nature and characteristic features of the invention will be more readily understood from the following description taken in connection with the accompanying drawing forming part hereof in which:

FIG. 1 is a diagrammatic, side elevational, sectional view of the deployable submarine hydroelectric generator, showing its vessel body with electric generator inside, gear transmission, clutch, turbine, electric transformer, winch and control module with antenna.

FIG. 2 is a diagrammatic, side elevational view of the deployable submarine hydroelectric generator anchored to the bottom of the ocean by a winch cable and having self-steering feature into the sea current by its fins and turbine blades' drag.

FIG. 3 is a diagrammatic, rear elevational view of the hydroelectric generator of the FIG. 2, showing the vertical and horizontal fins as well as cooling radiators, antenna and winch housing.

Like numerals refer to like parts throughout the several views and figures. It should, of course, be understood that the description and the drawings herein are merely illustrative, and it will be apparent that various modifications, combinations and changes can be made of the structures and the systems disclosed without departing from the spirit of the invention and from the scope of the appended claims.

### DESCRIPTION OF THE PREFERRED EMBODIMENTS

When referring to the preferred embodiments, certain terminology will be utilized for the sake of clarity. Use of such terminology is intended to encompass not only the described embodiment, but also all technical equivalents which operate and function in substantially the same way to bring about the same results.

Hydroelectric generator capturing energy of sea currents today are limited to tidal current type, which requires mounting the generator on an undersea tower in relative shallow waters. This construction is expensive and not practical for deep ocean warm currents, such as Gulf Stream, and deep ocean cold currents.

Present invention employs a novel method of easy conversion of the solar/kinetic energy of deep ocean currents into clean electricity of virtually unlimited quantity at much lower construction and operational cost than the present methods and thus providing electricity for production of low cost hydrogen for fueling vehicles, which can accelerate our effort to be free from the imported oil.

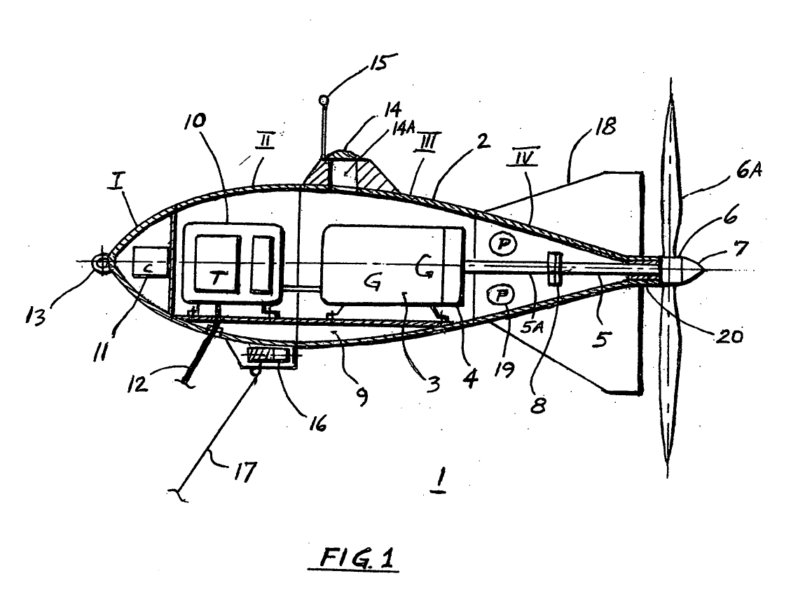

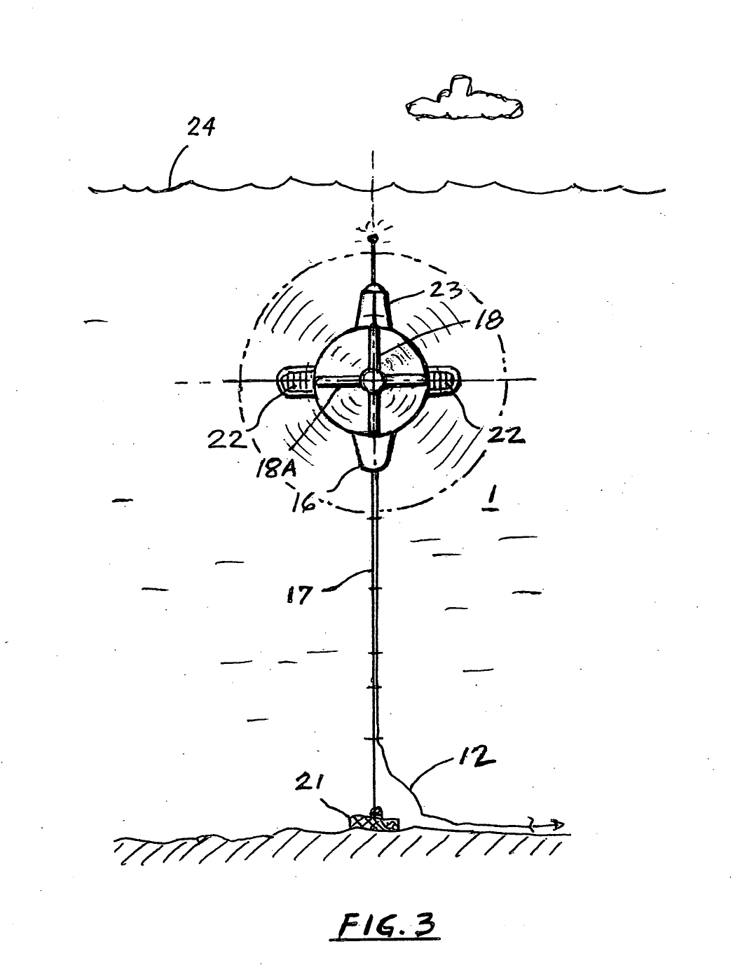

The invention will be better understood when referring in more details to the drawings of this patent and FIGS. 1 and 2 and 3, which is one embodiment of this invention, illustrating as an example deployable submarine-hydroelectric generator 1, comprising hermetically sealed vessel 2 containing preferably alternating current electric generator 3 with optional gear box 4 connected by shaft 5, to outside turbine 6A with blades 6, which shaft is sealed and supported by bearing/seal 20. Turbine 6A may have an optional cone 7 mounted on its center line.

The shaft 5 may have an optional electric clutch 8 connecting it to the gear box 4 shaft 5A. Clutch 8 can disconnect the generator 3 from the turbine 6A when needed. Additionally, the blades 6 may be “feathered”, and stopped by optional electric brake 8A. The vessel 2 may also contain transformer 10 for high voltage exiting cable 12, and radio command, control and communication unit 11. The vessel 2 may also have lug 13 on its front end for a towing cable attachment (not shown), for deploying (towing) the submarine generator to a desired location or a service station. The unit 11 is electrically connected to antenna 15, which can receive and/or transmit signals from and to an outside command center, on a ship or land.

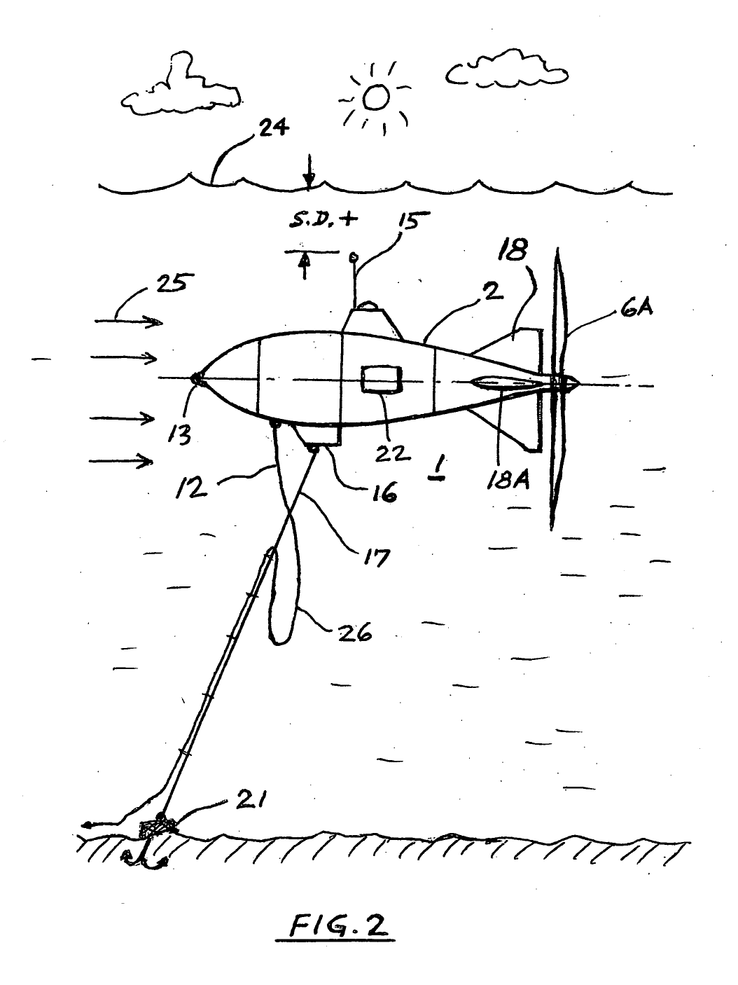

The vessel 2 may also have manhole entry 14A in tower 23, covered by sealed, removable lid 14 for servicing the generator and other described components. Another important component is electric winch 16 mounted on the bottom of the vessel, and which winch can wind or unwind on command anchoring cable 17 anchored to the bottom of the ocean by heavy block anchor 21. The drag of the turbine acts as a weather vane and steers the vessel 2 properly against the sea current 25 direction; and the vessel 2 is also auto-steered by at least one vertical fin 18. At least one horizontal fin 18A prevents the vessel 2 from being dragged down by the current 25 due to the attachment to the bottom of the sea just by the cable 17. The fins 18A create lift, and more so, when the angle of attack increases by vessel 2 trying to descent down on a radius of the cable 17 length. When the tail end drops down, the fins 18A create more lift. This then pushes the tail and the vessel up into proper original location and position and makes it dynamically stable. This phenomenon was observed on a model during reduction of this invention into practice. This provides for anchored combination of hydrostatic and hydrodynamic vehicle, as a carrier of the electric generator. The fins 18 and 18A, with the cable 17 also prevent the vessel 2 from spinning around its longitudinal axis, due to the torque of the turbine blades 16. The attachment of the cable 17 to the submarine vessel 2 and/or the winch location should be forward of the center of buoyancy of the vessel, to dynamically stabilize it in the current. The exiting electric cable 12 should have an extra necessary length loop 26 for elevation of the vessel 2 to the ocean or sea surface, without being wound into the winch 16 together with the anchoring cable 17. The cable 12 may be also easily disconnectable from the vessel 2 by induction based, sealed plug 12A, which can transmit electricity through the wall of the vessel 2, without exposing the wires to the water when disconnected. The winch 16 may be also easily detachable from the vessel 2, and may be then attached to a float with radio ID signal (not shown). This makes possible the hydroelectric generator to be towed into a service station or another location, if needed. The vessel 2 may be constructed from hermetically sealed but detachable sections I, II, III, and IV, as shown in FIG. 1. The vessel 2 should be balanced, so it maintains approximately horizontal position (level) of its longitudinal axis and is out of sight, submerged at any desirable depth in the sea current. The depth “S.D.” should be more than any ship's keel depth as shown in FIG. 2. The vessel 2, after anchoring should also have a remotely (wirelessly) controlled neutral to positive buoyancy, so when a servicing is needed, it can be brought to the sea surface by unwinding the anchoring cable by a remote controls, and additionally pumping water by electrical pumps from the ballast chamber(s) 9. It is understood that all electrically controlled functions of described components, such as electrical winch, electrical clutch and brake, and pumps are executed through the radio command and control unit 11 by electric cable 12 from the generator 3 and/or the transformer 10 can follow the anchoring cable 17 to the bottom of the sea, and then continues to the nearby coast and on the land surface (or underground), where it can be connected to an electric power station and electric grid (not shown), or it can be connected to an electrolyzer on the land to produce clean hydrogen by electrolysis of water (not shown). The hydrogen fuel can be stored under high pressure and sold for fueling and driving vehicles, or for a chemical process. The Gulf Stream, for example, flows only a few miles from the Florida coast, so it can supply practically unlimited electricity to that state and beyond. Virtually unlimited quantity of these generators can be placed into it. If these generators are placed far from the land, they still can be anchored to the bottom of the sea, but the electricity can be tapped from them by connecting and tying ships to them, which ships can have on-board electrolyzers to produce hydrogen from the sea water and transporting the stored hydrogen to the land, or anywhere it is needed, including powering said ships, or other ships. My prior U.S. Pat. No. 7,036,616B1 describes long range hydrogen-electric hybrid vehicles, which can be the primary consumers of this indefinite source of hydrogen and clean energy; or this electricity can be used to charge easily converted plug-in hybrid vehicles as described in my patent application Ser. No. 11/818,374, or to charge Navy submarines. These inventions will thus reduce global warming and eliminate our dependence on foreign oil. If all military vehicles would be converted to hydrogen fuel, as described, this fuel can be produced on ships located at the closest sea current to the conflict. It should be noted that the submersible hydroelectric generators can be deployed (towed) by ships or submarines to the desired location, and will thus eliminate shipping of oil fuel for military operations worldwide, saving billions of dollars. The turbine blades can be “feathered” during towing, to reduce drag. The described deployable submarine—hydroelectric generators may include in its vessels also a high voltage transformer 10 as shown in FIG. 1, and the generator can be alternator for AC current and 3-phase type. This provides for a long distance “transport” of electricity by a thinner cable (=lighter and cheaper), similar to land power grid system. The weight of the electric components is not a problem in a water submersible vessel, which can easily carry very heavy loads, unlike airborne vehicles. The cooling of the transformer and generator can be by water cooled heat exchangers (radiators) 22, with pumps (not shown) driven by the turbine or the electricity from the generator. The vessel's 2 shell and the anchoring cable 17 should be preferably made from stainless steel, to guarantee long operational life. The electric cable 12 should be of a well known undersea type design, and the cooling liquid of the transformer and/or generator can be silicon oil. A practical example and “proof of concept” of this invention can be tested on a small scale as follows:

An existing small generator can be enclosed in a proportionate size, sealed vessel with a turbine as described above, and anchored under water in a river stream. The cable from the generator can be connected on the river bank to an electrical load, such as a bulb, electric motor, or electrolyzer, and this generator can be tested, and used. It is apparent that this invention is also useable for tapping into river streams energy, without building dams. In the remote control system, GPS (global positioning system) should be included, as well as ID (identification) radio signal system, so each generator can be easily found. These generators are also environmentally friendly due to their “invisibility” and absence of unsightly structures, unlike windmills. These generators will also be unaffected by any weather above, such as hurricanes.

Another application for this electric generator type is for generating electricity from sea currents at the bottom of the ocean for powering undersea sensors and sonobuoys of the Navy, which can eliminate the use of batteries and their frequent replacement or servicing.

This generator construction is also usable to capture energy of tidal currents and at much lower cost than the underwater tower. This electric generator of the invention can also be easily rotated (swung) on the anchoring cable in changing directions of such currents. It should be noted, that the described deployable hydroelectric generator may be built in any size from micro-applications to full size power plant, equivalent to standard electric coal burning power plants for cities. The ocean and its currents are big enough to absorb and accept such large generators/vessels. Also, the shape of the vessel containing the electric components is not limited to the example shown, and may be virtually any suitable hydrodynamic shape, anchored by a cable. Due to slowly revolving turbine blades (approximately 20 RPM), these generators are also very friendly to the environment, and the sea life can easily avoid them. A cluster, or a quantity of these described generators can be also connected to one electric cable carrying electric current to the land power station.

It should, of course, be understood that the description and the drawings herein are merely illustrative and it will be apparent that various modifications, combinations and changes can be made of the structures and systems disclosed without departing from the spirit of the invention and from the scope of the appended claims.

It will thus be seen, that novel and more economical method and structures for clean energy of ocean currents harnessing has been provided, with which the objects of the invention are achieved.

I claim:

1. A deployable submersible hydroelectric generator for ocean currents kinetic energy harvesting, comprising:
a hermetically sealed, hydrodynamically shaped and hydrodynamically and hydrostatically stabilized vessel, in approximately horizontal position, and said vessel having center of buoyancy and front and rear ends;
an anchoring line, which anchors said vessel to bottom of an ocean at a selected depth;
at least one vertical and horizontal fin each, mounted on said rear end of said vessel in lengthwise direction;
an electric generator mounted inside of said vessel;
a turbine with blades mounted on said rear end and outside of said vessel and connected to said electric generator by a sealed shaft;
an electric cable having wires electrically connecting said electric generator with a land or naval electric grid load;
and in which said hydroelectric generator said turbine drives said electric generator by said blades rotated by said ocean current kinetic energy, and said blades are source of hydrodynamic drag applied to said vessel,
and which vessel is self-steered against direction of ocean current by said fins and by said turbine blades drag.

2. A deployable hydroelectric generator as described in claim 1, which generator additionally includes a transformer for high voltage transmission of said electric generator electric current.

3. A deployable hydroelectric generator as described in claim 1, which generator additionally includes a winch for winding and unwinding said anchoring line, which adjusts said generators' depth of submersion.

4. A deployable hydroelectric generator as described in claim 3, in which said electric cable has a loop, which loop has a length permitting to raise said vessel to the sea surface without having said electric cable wound onto said winch.

5. A deployable hydroelectric generator as described in claim 1, which hydroelectric generator is remotely controlled, and which remote controls are selected from the group which includes:
said vessel submersion depth control, disconnect of said turbine from said electric generator, said turbine braking and stop, global positioning system with identification signal, and said turbine blades feathering.

6. A deployable hydroelectric generator as described in claim 1, in which said turbine blades can be feathered and their rotation can be stopped by a brake.

7. A deployable hydroelectric generator as described in claim 1, in which said anchoring line is a cable.

8. A deployable hydroelectric generator as described in claim 1, which hydroelectric generator has adjustable buoyancy from neutral to positive by a ballast.

9. A deployable hydroelectric generator as described in claim 1, which hydroelectric generator is towable in a sea, and is deployable in desired location.

10. A deployable hydroelectric generator as described in claim 1, in which said anchoring line is attached forward of said center of buoyancy.

11. A deployable hydroelectric generator as described in claim 1, which hydroelectric generator is used to produce hydrogen by electrolysis of water.

12. A plurality of deployable hydroelectric generators as described in claim 1, which generators are mechanically and electrically connected together and transmit electric current through an electric cable to a land or naval electric load.

13. A deployable hydroelectric generator as described in claim 1, which is also used for rivers and ocean tidal currents kinetic energy conversion into electric energy.

14. A deployable hydroelectric generator as described in claim 1, in which said electric generator is alternating current generator.

15. A method of ocean current kinetic energy conversion into electric energy, which comprises steps of:
providing hermetically sealed, hydrodynamically shaped and hydrodynamically and hydrostatically horizontally stabilized vessel, said vessel having center of buoyancy and front and rear ends, said vessel containing an electric generator connected by a sealed shaft to a turbine with blades mounted on said rear end and outside of said vessel;
providing at least one vertical and horizontal fin each, mounted on said vessel's rear end in longitudinal direction;
providing an electric cable having wires electrically connected to said electric generator and electric load;
providing an anchoring cable with an anchor;
towing said vessel into a selected location in an ocean current;
attaching said cable forward of center of said buoyancy of said vessel;
and anchoring said vessel at selected depth to bottom of an ocean by said cable and said anchor;
and which anchoring causes self-steering of said vessel against said ocean current direction and spinning of said turbine blades by ocean current kinetic energy and driving said electric generator, producing electric energy to be transmitted to an electric load via said electric cable.

16. A method of sea current kinetic energy conversion into electric energy as described in claim 15, in which said electric generator is alternating current generator.

17. A method of ocean current kinetic energy conversion into electric energy as described in claim 15, which additionally include providing a high voltage transformer inside of said vessel, for high voltage current transmission through said electric cable.

18. A method of ocean current kinetic energy conversion into electric energy as described in claim 15, which additionally include providing an induction based, sealed plug for said electric cable, which plug makes possible disconnecting said cable from said electric generator without exposing said wires of said cable to water.

19. A method of ocean current kinetic energy conversion into electric energy as described in claim 15, which additionally includes providing a detachable electric winch, attached to said vessel for winding and unwinding said anchoring cable.
